(19) United States
(12) Patent Application Publication
(10) Pub. No.: US 2026/0147352 A1
(43) Pub. Date: May 28, 2026

(54) Real-Time Path Generation Method and System for Corner Turning of Robot

(71) Applicants: Hyundai Motor Company, Seoul (KR); Kia Corporation, Seoul (KR)

(72) Inventor: Hwanhee Lee, Hwaseong-Si (KR)

(21) Appl. No.: 19/247,412

(22) Filed: Jun. 24, 2025

(30) Foreign Application Priority Data
Nov. 25, 2024 (KR) 10-2024-0169288

(51) Int. Cl. G05D 1/622

(52) U.S. Cl. CPC G05D 1/622

(57) ABSTRACT

A method performed by an apparatus of a robot includes generating a cost map for surrounding areas of the robot based on a grid map and information regarding an obstacle detected by a sensor of the robot, wherein the surrounding areas are within a threshold distance from the robot, generating a shortest avoidance path from a current position of the robot to a destination, detecting a blocked region outside a sensor detection region, detecting a blocked region entry point, generating a corner turning path, determining whether a field of view of the sensor has been secured at every preset time interval, generating one of the shortest avoidance path and the corner turning path as a final path, outputting a signal indicating the final path, and controlling, based on the signal, movement of the robot.

### CROSS-REFERENCE TO RELATED APPLICATION

This application claims the benefit of priority to Korean Patent Application No. 10-2024-0169288 filed in the Korean Intellectual Property Office on Nov. 25, 2024, the entire contents of which are incorporated herein by reference.

### TECHNICAL FIELD

The present disclosure relates to real-time path generation method and system for corner turning of a robot.

### BACKGROUND

The matters described in this Background section are only for enhancement of understanding of the background of the disclosure, and should not be taken as acknowledgment that they correspond to prior art already known to those skilled in the art.

Utilization of mobile robots such as indoor/outdoor delivery robots, service robots, and patrol robots has been increasing. Most of these mobile robots may perform tasks based on an autonomous driving technology. In order for a mobile robot to autonomously drive from a current location to a destination location, a real-time path planning technology capable of actively avoiding obstacles is desirable. Furthermore, there is a growing need for a technology that may prevent collisions with obstacles located in regions that are difficult for sensors to detect in advance, such as when turning a corner.

When attempting to turn a corner, a mobile robot that is not programmed with a specialized corner turning strategy follows along a path that turns relatively close to the corner in order to take the shortest route. In this case, it may be difficult to secure safety with respect to an object approaching from the opposite side of the corner, which is a region that is difficult for a sensor to detect.

In one example of a robot corner turning method, a robot may decelerate or temporarily stop and then resume driving when turning a corner. However, such method may not fundamentally prevent collisions with objects approaching from the opposite side of the corner.

In another example of a robot corner turning method, a path that makes a large turn at each corner may be defined in advance, and a robot may follow the path. However, such method may require that a path be predefined for all corners and lack flexibility in responding to environments that change moment by moment. In particular, it may be difficult to handle situations where an unexpected obstacle exists along the predefined path.

In addition, even in a case of following a path that turns around a corner, a heading direction of the robot follows a proceeding direction of the path, making it difficult to respond in advance to an obstacle approaching from the opposite side of the corner.

### SUMMARY

The present disclosure attempts to provide real-time path generation method and system for corner turning of a robot capable of securing safety for objects approaching from an opposite side of a corner by generating a path that makes a large turn around the corner based on real-time obstacle information and securing a field of view for an opposite region of the corner.

According to the present disclosure, a method performed by an apparatus of a robot, the method comprising, based on a grid map and information regarding an obstacle detected by a sensor of the robot, generating a cost map for surrounding areas of the robot, wherein the surrounding areas are within a threshold distance from the robot, generating, based on the cost map, a shortest avoidance path from a current position of the robot to a destination such that the shortest avoidance path bypasses the obstacle, detecting a blocked region that is outside a sensor detection region detected by the sensor at the current position of the robot, detecting, based on the shortest avoidance path and the blocked region, a blocked region entry point, generating, based on the shortest avoidance path and the blocked region entry point, a corner turning path, determining whether a field of view of the sensor has been secured at every preset time interval, generating, based on the determining, one of the shortest avoidance path and the corner turning path as a final path, outputting a signal indicating the final path, and controlling, based on the signal, movement of the robot.

The method, wherein the detecting of the blocked region entry point comprises, checking, for each node included in the shortest avoidance path sequentially from the current position of the robot to the destination, whether the node belongs to the sensor detection region or the blocked region, and identifying, as the blocked region entry point, a first node that transitions from the sensor detection region to the blocked region.

The method, wherein the determining of whether the field of view has been secured comprises, setting a certain section following the blocked region entry point as a blocked interest region, accumulating the blocked interest region to generate an accumulated blocked interest region, wherein the blocked interest region is accumulated from an initial time to a current time, and wherein the initial time is a time at which the shortest avoidance path is generated, and determining whether the accumulated blocked interest region is detected by the sensor.

The method, wherein the determining of whether the field of view has been secured comprises, determining that the field of view has been secured based on the accumulated blocked interest region being entirely detected, or determining that the field of view has not been secured based on the accumulated blocked interest region being partially detected.

The method, wherein the generating of one of the shortest avoidance path and the corner turning path as the final path comprises, generating, based on determining that the field of view has been secured, the shortest avoidance path as the final path.

The method, wherein the generating of one of the shortest avoidance path and the corner turning path as the final path comprises, generating, based on determining that the field of view has not been secured, the corner turning path as the final path.

The method, wherein the controlling of the movement of the robot comprises controlling movement of the robot along the final path. The method, further comprising, assigning a heading direction to each final node included in the final path, setting, based on the final path and the heading direction, a target heading direction for each final node, and controlling, based on the target heading direction, the field of view of the sensor.

The method, wherein the assigning of a heading direction comprises, assigning, as the heading direction for each final node, a direction toward, a location that is ahead on the final path by a preset distance, or a final node that is ahead by a preset number of nodes.

The method, wherein the setting of the target heading direction comprises, based on a driving state of the robot, setting the target heading direction by adding, an additional distance to a preset distance assigned to each final node, or an additional number to a preset number assigned to each final node.

According to the present disclosure, an apparatus of a robot, the apparatus comprising, a processor, and a memory storing at least one instruction that, when executed by the processor communicating with the memory, is configured to cause the apparatus to, detect, using a sensor of the robot, sensor data within a field of view of the sensor, and based on a grid map and the sensor data, generate a cost map for surrounding areas of the robot, wherein the surrounding areas are within a threshold distance from the robot, generate, based on the cost map, a shortest avoidance path from a current position of the robot to a destination such that the shortest avoidance path bypasses an obstacle, wherein the obstacle is detected based on the sensor data, detect a blocked region that is outside a sensor detection region detected by the sensor at the current position of the robot, detect, based on the shortest avoidance path and the blocked region, a blocked region entry point, generate, based on the shortest avoidance path and the blocked region entry point, a corner turning path, determine whether a field of view of the sensor has been secured at every preset time interval, generate, based on the determination, one of the shortest avoidance path and the corner turning path as a final path, output a signal indicating the final path, and control, based on the signal, movement of the robot.

The apparatus, wherein the at least one instruction, when executed by the processor communicating with the memory, is configured to cause the apparatus to detect the blocked region entry point by, checking, for each node included in the shortest avoidance path sequentially from the current position of the robot to the destination, whether the node belongs to the sensor detection region or the blocked region, and identifying, as the blocked region entry point, a first node that transitions from the sensor detection region to the blocked region.

The apparatus, wherein the at least one instruction, when executed by the processor communicating with the memory, is configured to cause the apparatus to determine whether the field of view has been secured by, setting a certain section following the blocked region entry point as a blocked interest region, accumulating the blocked interest region to generate an accumulated blocked interest region, wherein the blocked interest region is accumulated from an initial time to a current time, and wherein the initial time is a time at which the shortest avoidance path is generated, and determining whether the accumulated blocked interest region is detected by the sensor.

The apparatus, wherein the at least one instruction, when executed by the processor communicating with the memory, is configured to cause the apparatus to, determine, based on the accumulated blocked interest region being entirely detected, that the field of view has been secured, and determine, based on the accumulated blocked interest region being partially detected, that the field of view has not been secured.

The apparatus, wherein the at least one instruction, when executed by the processor communicating with the memory, is configured to cause the apparatus to generate, based on determining that the field of view has been secured, the shortest avoidance path as the final path.

The apparatus, wherein the at least one instruction, when executed by the processor communicating with the memory, is configured to cause the apparatus to generate, based on determining that the field of view has not been secured, the corner turning path as the final path.

The apparatus, wherein the at least one instruction, when executed by the processor communicating with the memory, is configured to cause the apparatus to control the movement of the robot along the final path.

The apparatus, wherein the at least one instruction, when executed by the processor communicating with the memory, is configured to cause the apparatus to, assign a heading direction to each final node included in the final path, set, based on the final path and the heading direction, a target heading direction for each final node, and control, based on the target heading direction, the field of view of the sensor.

According to the present disclosure, a method performed by an apparatus of a vehicle, the method comprising, obtaining information related to an environment of the vehicle, generating, based on the obtained information, a path for movement of the vehicle from a current position toward a destination, identifying a region along the path, determining whether the region is entirely within a sensing range of a sensor of the vehicle, based on the determination of whether the region is entirely within the sensing range, adjusting the path, outputting a signal indicating the adjusted path, and controlling, based on the signal, the movement of the vehicle.

The method, wherein the identifying of the region comprises, identifying a blocked region entry point at which the path transitions from a sensor detection region into a region not currently detected by the sensor, and defining the region as a blocked interest region that includes a portion of the path following the blocked region entry point, and wherein the vehicle comprises a robot.

Other effects that may be obtained or are predicted from an example of the present disclosure will be explicitly or implicitly described in a detailed description of the example of the present disclosure. For example, various effects that are predicted from an example of the present disclosure will be described in the following detailed description.

### BRIEF DESCRIPTION OF THE DRAWINGS

Examples of the present disclosure may be better understood with reference to the following description taken in conjunction with the accompanying drawings, in which like reference numerals denote identical or functionally similar elements:

FIG. 1 shows an example of a real-time path generation system for corner turning of a robot according to an example of the present disclosure;

FIG. 2 shows an example of generation of a shortest avoidance path based on a cost map;

FIG. 3 shows an example of detection of a blocked region entry point based on the shortest avoidance path of FIG. 2;

FIG. 4 shows an example of generation of a corner turning path based on a cost map;

FIGS. 5 to 9 show an example of a process of accumulating a blocked interest region over time, wherein:

FIG. 5 shows an example of detection of a blocked region entry point at an initial time t0;

FIG. 6 shows an example of an accumulated blocked interest region accumulated up to a first time t1;

FIG. 7 shows an example of accumulated blocked interest region accumulated up to a second time t2;

FIG. 8 shows an example of accumulated blocked interest region accumulated up to a third time t3; and

FIG. 9 shows an example of accumulated blocked interest region accumulated up to a fourth time t4;

FIG. 10 shows an example of selecting a path based on whether a field of view has been secured; and

FIG. 11 shows an example of a real-time path generation method for corner turning of a robot according to another example of the present disclosure.

It is to be understood that the drawings referenced above are not necessarily drawn to scale, and present somewhat simplified representations of various preferred features showing the basic principles of the present disclosure. Specific design features of the present disclosure as included herein, including, for example, specific dimensions, orientations, locations, and shapes will be determined in part by the particularly intended application and use environment.

### DETAILED DESCRIPTION

Terms used herein are for describing particular examples and are not intended to limit the present disclosure. As used herein, singular forms are intended to include plural forms as well, unless the context clearly indicates otherwise. It is to be further understood that the terms “includes” and/or “including” used in the present specification specify the presence of stated features, integers, steps, operations, elements, and/or components, but do not preclude the presence or addition of one or more other features, integers, steps, operations, components, and/or combinations thereof. As used herein, the term “and/or” includes any or all combinations of one or more of the associated listed items.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “robot” or other similar terms as used herein may include general land-mobile robots such as passenger cars including sports utility vehicles (SUVs), buses, trucks, various commercial vehicles, marine-mobile robots such as various boats and ships, aerial-mobile robots such as aircraft and drones, and any object that may be moved by receiving power from a power source. It is to be understood that the term “robot” or other similar terms as used herein may include hybrid powered robots, electric powered robots, plug-in hybrid powered robots, hydrogen powered robots, and other alternative fuel (for example, fuels derived from resources other than petroleum) robots. As used herein, the hybrid powered robots may include robots having two or more power sources, for example, gasoline powered and electric powered robots. A robot according to an example of the present disclosure may include a robot that is somewhat autonomously driven as well as a robot that is fully autonomous or is driven in an automated manner.

In addition, it is understood that one or more of the following methods or the examples thereof may be executed by at least one controller. The term “controller” may refer to a hardware device including a memory and a processor. The memory is configured to store program commands, and the processor is specially programmed so as to execute program commands to perform one or more processes described in more detail below. The controller may control operations of units, modules, components, devices, or similar matters as described herein. Further, it is understood that the following methods may be executed by a device including the controller together with one or more other components as recognized by those skilled in the art.

Further, the controller according to the present disclosure may be implemented as a non-transitory computer-readable recording medium including program commands executable by a processor. Examples of the computer-readable recording medium may include a read only memory (ROM), a random access memory (RAM), a compact disc (CD) ROM, magnetic tapes, floppy discs, flash drives, smart cards, and optical data storage devices, but the computer-readable recording medium is not limited thereto. The computer-readable recording medium may also be distributed across a computer network such that program commands are stored and executed by a distributed method such as a telematics server or a controller area network (CAN).

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of corner turning) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of corner turning) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of corner turning) described herein.

Minimum risk maneuver (MRM) operation(s) may also be controlled, for example, based on one or more features (e.g., feature of corner turning) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of corner turning) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of corner turning) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

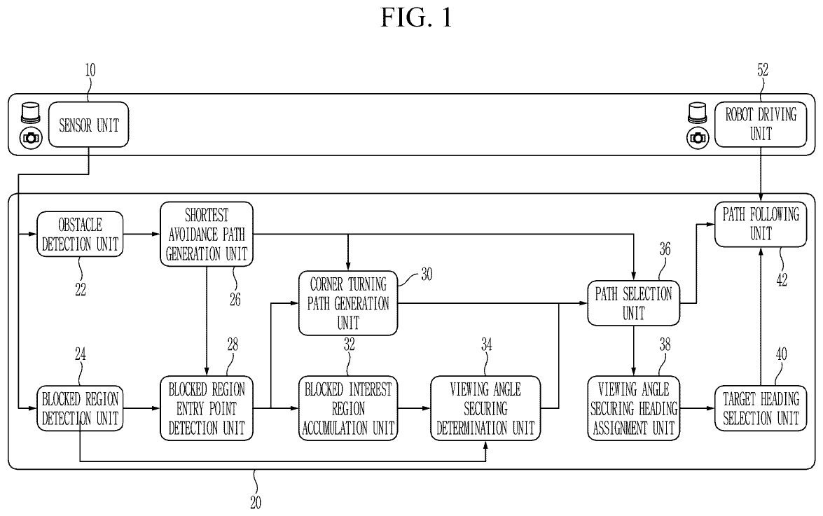

FIG. 1 shows an example of a real-time path generation system for corner turning of a robot according to an example of the present disclosure.

As shown in FIG. 1, a real-time path generation system for corner turning of a robot 50 according to an example of the present disclosure may include a sensor unit 10, a controller 20, and a robot 50.

The sensor unit 10 may be mounted on the robot 50 and may include any sensor capable of detecting an obstacle within a field of view, such as a light detection and ranging (LiDAR), a camera, or a radar detection and ranging (radar) (e.g., ultrasonic sensors, stereo vision cameras, infrared sensors, or depth sensors, etc.). Here, the term “obstacle” or other similar terms may mean an object such as a building, a wall, or a person that impedes movement of the robot 50 or that the robot 50 may not pass through (e.g., furniture, parked vehicles, glass walls, or pillars, etc.). The term “obstacle” or other similar terms may mean an object that occupies a physical space and is within a range of a height of the robot 50. The sensor unit 10 may be connected so as to transmit data to the controller 20 and may transmit sensor data 68 detected within the field of view to the controller 20 for further processing, such as obstacle detection, region classification, or path planning.

The controller 20 may receive the sensor data 68 from the sensor unit 10, generate a path for autonomous driving of the robot 50 based on the sensor data 68, and control the autonomous driving of the robot 50 according to the generated path (e.g., by issuing driving, steering, or heading adjustment commands, etc.). To this end, the controller 20 may be implemented by one or more processors operating according to a set program, and the set program may be programmed to perform each step of a real-time path generation method for corner turning of the robot 50 according to an example of the present disclosure (e.g., path generation, heading assignment, region analysis, or decision-making logic, etc.). The controller 20 may include an obstacle detection unit 22, a shortest avoidance path generation unit 26, a blocked region detection unit 24, a blocked region entry point detection unit 28, a corner turning path generation unit 30, a blocked interest region accumulation unit 32, a viewing angle securing determination unit 34, a path selection unit 36, and a path following unit 42 (e.g., implemented as software modules, firmware components, or hardware accelerators, etc.).

The obstacle detection unit 22 may detect the obstacle based on the sensor data 68 received from the sensor unit 10, and transmit information regarding the detected obstacle to the shortest avoidance path generation unit 26. The information regarding the obstacle may include a presence, a type, a position, or the like of the obstacle (e.g., static obstacles, dynamic pedestrians, moving carts, or reflective surfaces, etc.). The obstacle detection unit 22 may store an obstacle detection logic that detects the obstacle from the sensor data 68, and the obstacle detection logic may be a point-cloud-based logic, an image-based logic, a deep-learning-based logic, a sensor-fusion-based logic, or the like (e.g., YOLO, SSD, semantic segmentation, or Kalman filter-based fusion, etc.). The obstacle detection logic is not particularly limited, and an appropriate obstacle detection logic known to those skilled in the art may be used depending on the robot's operational context and sensor configuration.

The shortest avoidance path generation unit 26 may include a cost map generation unit, and the cost map generation unit may store a grid map (e.g., a two-dimensional or three-dimensional spatial representation divided into uniform cells, etc.). The cost map generation unit may generate an occupancy grid map based on the information regarding the obstacle received from the obstacle detection unit 22 and the grid map (e.g., by marking occupied, free, or unknown cells depending on obstacle presence, etc.). In addition, the cost map generation unit may generate a cost map 60 for surroundings of the robot 50 based on the occupancy grid map and the information regarding the obstacle (e.g., obstacle size, proximity, type, or velocity, etc.).

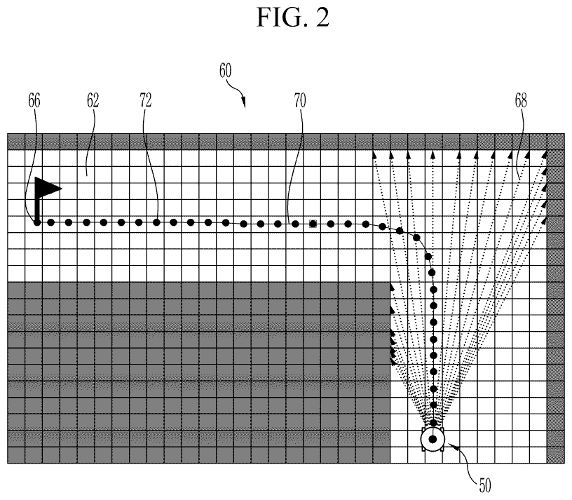

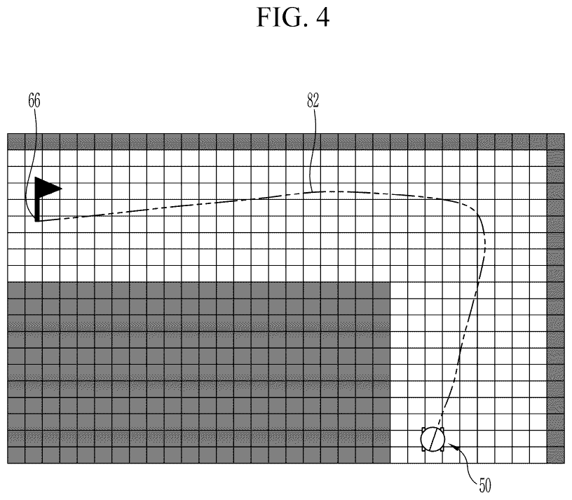

The grid map may refer to a map that divides a physical space where the robot 50 may drive, such as the ground or a floor, into a plurality of cells 62 of the same size (e.g., 10 cm×10 cm, 20 cm×20 cm, or any resolution appropriate for the application, etc.). The occupancy grid map may refer to a map that displays (for example, in dark gray), records, or stores occupancy by the obstacle on the grid map based on the information regarding the obstacle. The cost map 60 may refer to a map that displays, records, or stores a cost required for the robot 50 to pass through the cell 62 (e.g., assigning higher cost to narrow passages, dynamic regions, or areas near detected obstacles, etc.). It should be understood that the cost of the cell 62 has been omitted in order to simply and clearly show the cost map 60 in FIGS. 2 to 10.

The shortest avoidance path generation unit 26 may generate a shortest avoidance path 70 along which a destination 66 may be reached from the current position of the robot 50 while avoiding the obstacle, by using a path generation algorithm based on the cost map 60 generated by the cost map generation unit (e.g., selecting a path with minimal traversal cost through free or low-risk cells while bypassing high-cost or occupied areas, etc.). In one example, the shortest avoidance path generation unit 26 may generate a path with the lowest cost from the current position of the robot 50 to the destination 66 as the shortest avoidance path 70 based on the cost map 60 (e.g., by evaluating cumulative cell costs along candidate paths using a heuristic search strategy, etc.). However, the path generation algorithm is not particularly limited, and may include at least one of various path generation algorithms (e.g., A, Dijkstra's algorithm, Jump Point Search, RRT, or hybrid graph-sampling methods, etc.).

FIG. 2 shows an example of generation of the shortest avoidance path based on the cost map. For example, as shown in FIG. 2, the shortest avoidance path generation unit 26 may generate, based on the cost map 60, the shortest avoidance path 70 along which the robot 50 may reach the destination 66 while avoiding the obstacle at the lowest cost (e.g., by minimizing or reducing accumulated traversal costs through safe and low-risk regions, etc.). The shortest avoidance path 70 may include a plurality of nodes 72 that the robot 50 needs to pass through, and the plurality of nodes 72 may include a node 72 corresponding to the current position of the robot 50, a node 72 corresponding to the destination 66, and at least one node 72 between the nodes 72 (e.g., waypoints along a corridor, at hallway intersections, or around obstacles, etc.). The plurality of nodes 72 included in the shortest avoidance path 70 may be set such that a distance between neighboring nodes 72 is the same, or one node 72 may be disposed for each cell 62 included in the shortest avoidance path 70 (e.g., by assigning one node per grid cell or at fixed spatial intervals, etc.). However, a method of setting the plurality of nodes 72 is not limited thereto.

The blocked region detection unit 24 may detect a blocked region 76, which is a region that is not detected by the sensor unit 10 at the current position of the robot 50, based on the sensor data 68 received from the sensor unit 10 (e.g., areas occluded by walls, shelves, or turning corners, etc.).

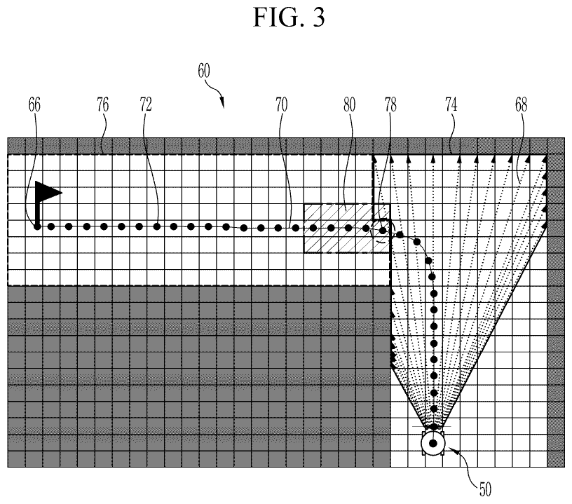

The blocked region entry point detection unit 28 may detect a blocked region entry point 78 by utilizing the shortest avoidance path 70 received from the shortest avoidance path generation unit 26 and the blocked region 76 received from the blocked region detection unit 24 (e.g., by identifying a transition point where the path enters an area outside the sensor's current field of view, such as a blind corner or occluded hallway, etc.). In addition, the blocked region entry point detection unit 28 may set, as a blocked interest region 80, a certain section around a preset number of nodes 72 following the blocked region entry point 78 and may use the blocked interest region 80 to determine whether or not a sufficient field of view has been secured (e.g., for early obstacle detection or safe turning before full sensor coverage is achieved, etc.). A process of detecting the blocked region entry point 78 and a process of setting the blocked interest region 80 will be described in more detail below with reference to FIG. 3.

FIG. 3 shows an example of detection of the blocked region entry point based on the shortest avoidance path of FIG. 2. In FIG. 3, a bold dotted line indicates the blocked region 76 and a bold solid line indicates a sensor detection region 74. As shown in FIG. 3, the blocked region entry point detection unit 28 may check which region among the sensor detection region 74 and the blocked region 76 each node 72 included in the shortest avoidance path 70 belongs to (e.g., by comparing each node's location with the current sensor visibility boundary, etc.). For example, the blocked region entry point detection unit 28 may check which region among the sensor detection region 74 and the blocked region 76 all nodes 72 belong to sequentially from the current position of the robot 50 to the destination 66, for example, to identify the first point of visibility loss. Then, the first node 72 that belongs to the sensor detection region 74 and then to the blocked region 76 is detected as the blocked region entry point 78 (e.g., the first node where the path enters a sensor-occluded zone, such as around a wall or corner, etc.). Then, the blocked region entry point detection unit 28 may set a certain section (5*3 cells) around a preset number of (for example, five) nodes 72 following the blocked region entry point 78 as the blocked interest region 80 (e.g., representing a critical area where visibility should be achieved in advance for safe maneuvering, etc.). In addition, it may be determined whether the blocked region entry point 78 is on the left side or the right side of the robot 50 to detect whether the robot 50 enters the corner by turning left or right (e.g., for use in selecting an appropriate turning strategy or heading allocation scheme, etc.). In the example of FIG. 3, the blocked region entry point 78 is positioned on the left side of the robot 50, so that it may be known that the robot 50 enters the corner by turning left.

The corner turning path generation unit 30 may generate a corner turning path 82 based on the shortest avoidance path 70 received from the shortest avoidance path generation unit 26 and the blocked region entry point 78 received from the blocked region entry point detection unit 28 by using a preset algorithm (e.g., rule-based, sampling-based, or grid-expansion-based path reshaping algorithms, etc.). For example, among directions orthogonal to a tangent line of the shortest avoidance path 70, the opposite side of a turning direction when entering the corner may be set as a search direction of the turning region for each node 72 included in the shortest avoidance path 70 (e.g., searching outward from the bend to avoid tight turns or blind spots, etc.). Thereafter, a point where a safe securing distance may be secured within a preset search distance of the corresponding search direction may be searched as a corner turning node by referring to the cost value of the cell 62 positioned in the search direction, and a set of all corner turning nodes may be generated as the corner turning path 82 (e.g., forming a widened arc to maintain visibility and obstacle clearance, etc.). The safety securing distance may be preset or may vary depending on a property of the obstacle (e.g., obstacle type, expected motion, or proximity threshold, etc.). The preset algorithm is not particularly limited, and may include at least one of various algorithms known to those skilled in the art that may generate the corner turning path (e.g., elastic bands, potential fields, or motion primitives, etc.).

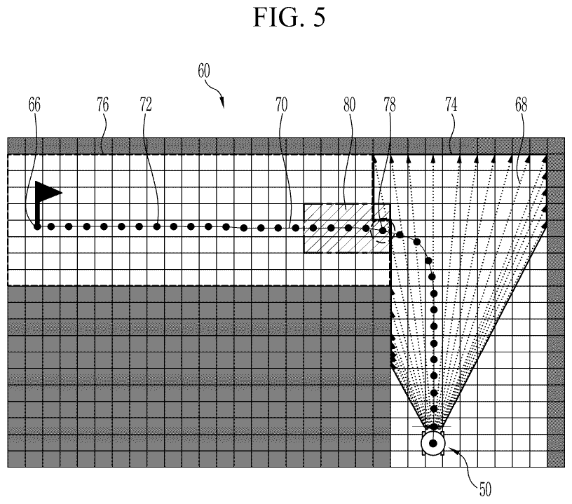

The blocked interest region accumulation unit 32 may accumulate the blocked interest region 80 transmitted from the blocked region entry point detection unit 28 from an initial time t0 at which the shortest avoidance path 70 is generated to a current time, thereby generating an accumulated blocked interest region 84 e.g., representing a union of all previously unobservable areas that require visibility before proceeding, etc.). Hereinafter, a process of accumulating the blocked interest region over time will be described with reference to FIGS. 5 to 9.

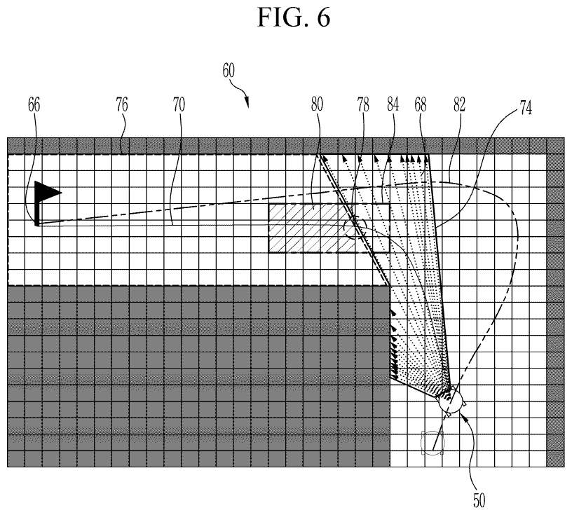

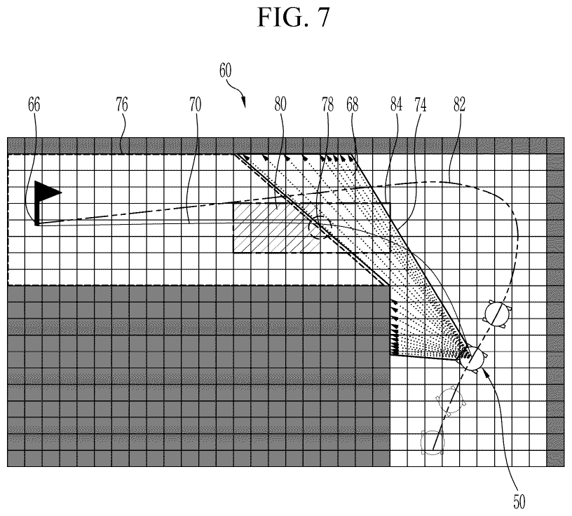

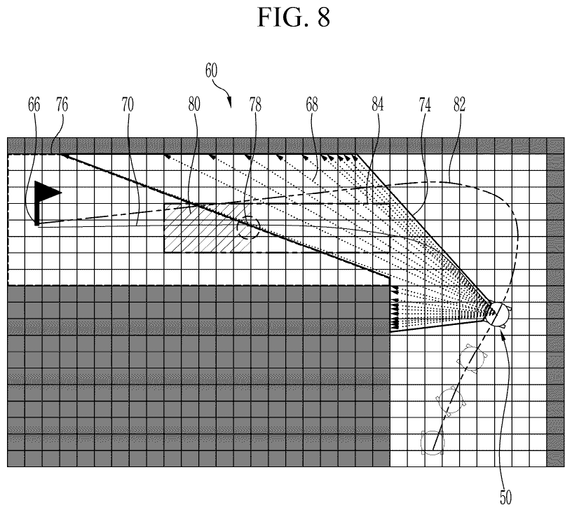

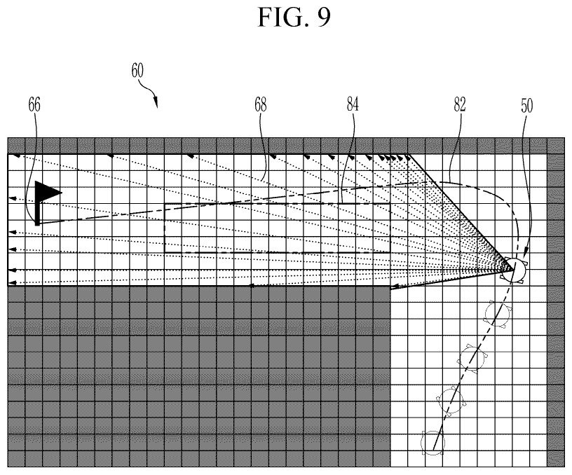

FIGS. 5 to 9 show the process of accumulating the blocked interest region over time, wherein FIG. 5 shows an example of detection of the blocked region entry point at the initial time t0, FIG. 6 shows the accumulated blocked interest region accumulated up to a first time t1, FIG. 7 shows the accumulated blocked interest region accumulated up to a second time t2, FIG. 8 shows the accumulated blocked interest region accumulated up to a third time t3, and FIG. 9 shows the accumulated blocked interest region accumulated up to a fourth time t4 (e.g., as the robot proceeds further into the occluded area during corner turning, etc.). In FIGS. 5 to 9, a thick dotted line indicates the blocked region 76, a thick solid line indicates the sensor detection region 74, the hatched region indicates the blocked interest region 80, and a square indicated by a thick line with alternating long and short dashes indicates the accumulated blocked interest region 84 (e.g., showing the union of previously unobservable but critical path segments, etc.).

As shown in FIG. 5, at the initial time t0, the blocked region entry point detection unit 28 may set, as the blocked interest region 80, the predetermined section (5*3 cells) around the preset number of (for example, five) nodes 72 following the blocked region entry point 78 and transmit the blocked interest region 80 to the blocked interest region accumulation unit 32 (e.g., identifying the first stretch of the path where visibility is insufficient but forward planning is needed, etc.). At the initial time t0, the blocked interest region 80 and the accumulated blocked interest region 84 are the same as each other.

Until the first time t1, the robot 50 may move along the corner turning path 82, and the sensor unit 10 may detect the sensor data 68 (e.g., including distance measurements, obstacle positions, or visibility limits, etc.) and transmit the sensor data 68 to the blocked region detection unit 24 (e.g., for continuous updating of detectable and non-detectable regions during movement). The blocked region detection unit 24 may detect, at the current position of the robot 50, the sensor detection region 74 detected by the sensor unit 10 and the blocked region 76 which is a region not detected by the sensor unit 10, based on the sensor data 68 (e.g., due to occlusion from walls, fixtures, or turning blind spots, etc.). As shown in FIG. 6, at the first time t1, the blocked region entry point detection unit 28 may detect the blocked region entry point 78, set a certain section (5*3 cells) following the blocked region entry point 78 as the blocked interest region 80 (e.g., a rectangular area covering upcoming nodes with limited visibility, etc.), and transmit the blocked interest region 80 to the blocked interest region accumulation unit 32 (e.g., for temporal tracking and evaluation of sensor coverage). The blocked interest region accumulation unit 32 may accumulate, on the blocked interest region 80 at the initial time t0, the blocked interest region 80 at the first time t1 to generate the accumulated blocked interest region 84 (e.g., incrementally building a composite target visibility area that must be secured before proceeding safely).

Until the second time t2, the robot 50 may move along the corner turning path 82, and the sensor unit 10 may detect the sensor data 68 (e.g., range measurements, reflected intensities, or camera images, etc.) and transmit the sensor data 68 to the blocked region detection unit 24. The blocked region detection unit 24 may detect the sensor detection region 74 and the blocked region 76 based on the sensor data 68 (e.g., by identifying occluded areas not currently visible to the sensors, such as behind corners or obstacles, etc.). As shown in FIG. 7, at the second time t2, the blocked region entry point detection unit 28 may detect the blocked region entry point 78, set a certain section (5*3 cells) following the blocked region entry point 78 as the blocked interest region 80 (e.g., defining the next portion of the occluded path to evaluate for visibility), and transmit the blocked interest region 80 to the blocked interest region accumulation unit 32. The blocked interest region accumulation unit 32 may accumulate, on the blocked interest region 80 at the first time t1, the blocked interest region 80 at the second time t2 to generate the accumulated blocked interest region 84 (e.g., continuously expanding the target region that the robot must eventually observe for safe navigation, etc.).

Similarly, the blocked interest region accumulation unit 32 may accumulate the blocked interest region 80 up to the third time t3 to generate the accumulated blocked interest region 84 as shown in FIG. 8, and accumulate the blocked interest region 80 up to the fourth time t4 to generate the accumulated blocked interest region 84 as shown in FIG. 9 (e.g., forming a complete record of occluded areas that remain unobserved as the robot progresses, etc.).

The viewing angle securing determination unit 34 may determine whether the field of view of the sensor unit 10 has been sufficiently secured based on the accumulated blocked interest region 84 transmitted from the blocked interest region accumulation unit 32 (e.g., by checking if all critical nodes are now within the current sensor visibility). In one example, as shown in FIG. 8, in a case where the sensor unit 10 does not detect even a portion of the accumulated blocked interest region 84, it may be determined that the field of view has not been sufficiently secured (e.g., requiring the robot to continue along the wider corner turning path). In another example, as shown in FIG. 9, in a case where the sensor unit 10 may detect the entire accumulated blocked interest region 84, it may be determined that the field of view has been sufficiently secured (e.g., allowing the robot to safely transition to a more direct path).

The path selection unit 36 may select one of the shortest avoidance path 70 transmitted from the shortest avoidance path generation unit 26 and the corner turning path 82 transmitted from the corner turning path generation unit 30 as a final path 86 based on:
information regarding whether the blocked region entry point 78 has been detected, which is transmitted from the blocked region entry point detection unit 28 (e.g., indicating the presence of a blind corner or occluded area that requires preemptive maneuvering, etc.),
information regarding whether the accumulated blocked interest region 84 exists, which is transmitted from the blocked interest region accumulation unit 32 (e.g., indicating whether previously occluded areas along the path still require visibility or further navigation planning, etc.), and
information regarding whether the field of view has been secured, which is transmitted from the viewing angle securing determination unit 34 (e.g., indicating whether all critical regions ahead of the robot are within the current sensor coverage to enable safe forward motion, etc.).
   For example, the detection of the blocked region entry point 78 may mean that the corner that the robot 50 needs to turn is positioned in front of the robot 50, and therefore, the path selection unit 36 may select the corner turning path 82 as the final path 86 (e.g., to proactively steer around a blind corner with limited visibility). In a case where the blocked region entry point 78 is not detected, it may be determined whether the accumulated blocked interest region 84 exists (e.g., to assess whether any previously occluded but relevant path segments still require visibility verification, etc.)In a case where no accumulated blocked interest region 84 exists, the absence of the accumulated blocked interest region 84 may mean that the corner that the robot 50 needs to turn is not positioned in front of the robot 50 (e.g., indicating that the robot is in an open area or fully observable corridor, and no special corner-turning maneuver is currently required, etc.), and thus, the path selection unit 36 may select the shortest avoidance path 70 as the final path 86 (e.g., because a direct and safe route is currently visible). In a case where the blocked region entry point 78 is not detected and the accumulated blocked interest region 84 exists, it may be determined whether the field of view has been secured (e.g., to evaluate if the robot has successfully observed all previously occluded regions despite not encountering a newly identified corner, etc.). In a case where the field of view has been secured, the path selection unit 36 may select the shortest avoidance path 70 as the final path 86 (e.g., indicating that previously occluded areas are now observable and navigable), and in a case where the field of view has not been secured, the path selection unit 36 may select the corner turning path 82 as the final path 86 (e.g., to maintain a safer route until full visibility is ensured).

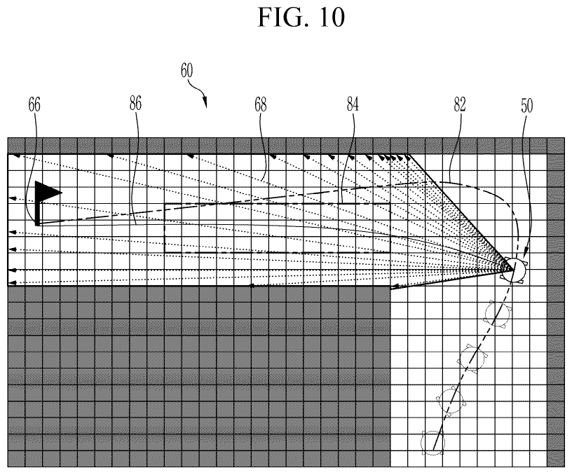

FIG. 10 shows an example of selecting the path based on whether the field of view has been secured. As shown in FIG. 10, the robot 50 may move along the corner turning path 82, the sensor unit 10 may detect the sensor data 68 (e.g., real-time obstacle and visibility data, etc.), the blocked region entry point detection unit 28 may detect the blocked region entry point 78, and the blocked interest region accumulation unit 32 may generate the accumulated blocked interest region 84 (e.g., by aggregating previously unobserved areas over time). The viewing angle securing determination unit 34 may determine whether the field of view has been sufficiently secured at every preset time interval (e.g., by verifying whether all target regions are within the sensor's current field of detection, etc.), and in a case where the field of view has not been sufficiently secured, the path selection unit 36 may select the corner turning path as the final path 86 (e.g., to continue navigating cautiously around the corner)In a case where the field of view has been sufficiently secured, the path selection unit 36 may select the shortest avoidance path 70 as the final path 86 (e.g., to resume direct movement toward the destination). For example, the path selection unit 36 may generate the shortest path (or an optimal path) that joins the shortest avoidance path 70 from a point in time when the field of view is sufficiently secured, and select a combination of the shortest path (or the optimal path) and the shortest avoidance path 70 as the final path 86 (e.g., by splicing the updated shortest route

with the previously followed safe detour path). The path following unit 42 may control driving and steering of the robot 50 such that the robot 50 follows the final path 86 transmitted from the path selection unit 36 (e.g., by issuing low-level commands to motors and steering actuators to track the selected trajectory, etc.).

The controller 20 may further include a viewing angle securing heading assignment unit 38 and a target heading selection unit 40 in order to secure the field of view as quickly as possible when making a large turn around the corner (e.g., to detect hidden obstacles or dynamic objects emerging from occluded regions, etc.).

The viewing angle securing heading assignment unit 38 may assign a heading direction advantageous for securing the field of view to each final node included in the final path 86 transmitted from the path selection unit 36 (e.g., by orienting the robot or its sensors toward regions ahead on the path to maximize forward visibility and minimize blind spots during navigation, etc.). In general, the field of view needs to be quickly secured when the robot 50 turns around the corner, and thus, the viewing angle securing heading assignment unit 38 may assign the heading direction advantageous for securing the field of view to each corner turning node included in the corner turning path 82 (e.g., by directing the robot's sensors to peer into upcoming occluded regions before entering them, etc.). For example, the viewing angle securing heading assignment unit 38 may set a direction so as to view a preset distance ahead on the corner turning path 82 from each corner turning node included in the corner turning path 82 (e.g., allowing the robot to anticipate upcoming obstacles or occluded zones before reaching them, thereby improving safety and responsiveness during the turn, etc.). More specifically, the viewing angle securing heading assignment unit 38 may set the heading direction for each corner turning node included in the corner turning path 82 so as to view a corner turning node that is a preset number ahead of the corresponding corner turning node (e.g., to maintain continuous forward visibility and avoid abrupt blind spots during turns). The preset distance or the preset number is not particularly limited, and may be set, for example, based on sensor characteristics, turning radius, or speed of the robot, etc. The viewing angle securing heading assignment unit 38 may assign the preset distance or the preset number to all corner turning nodes included in the corner turning path 82 (e.g., to uniformly orient the robot's field of view toward upcoming segments along the turn, regardless of path curvature or speed, etc.).

The target heading selection unit 40 may select a final target heading direction based on the final path 86 transmitted from the viewing angle securing heading assignment unit 38 and the heading directions assigned to all final nodes included in the final path 86 (e.g., by analyzing the forward-looking orientation of each node to determine an optimal gaze trajectory that enhances visibility along the predicted movement path, etc.). For example, the target heading selection unit 40 may set the target heading direction by adding an additional distance or additional number according to a driving state of the robot 50 to the preset distance or the preset number assigned to each final node (e.g., by extending the gaze further ahead during high-speed movement or sharper turns, etc.). The target heading selection unit 40 may transmit the target heading direction to the path following unit 42, and the path following unit 42 may control the robot 50, particularly the sensor unit 10, to be directed to the target heading direction (e.g., by adjusting the orientation of a LiDAR, camera gimbal, or steering mechanism to align with the intended viewing angle, etc.). By doing so, the robot 50 may be induced to drive as if the robot 50 views a certain distance ahead rather than right ahead at each final node (e.g., enabling proactive sensing and smoother path tracking). Therefore, the field of view may be secured in advance when the robot 50 turns around the corner.

The robot 50 may include at least an energy storage device and a robot driving unit 52, and the robot driving unit 52 may receive power from the energy storage device and drive the robot 50 such that the robot 50 follows the final path 86 under the control of the controller 20, particularly under the control of the path following unit 42 (e.g., by executing real-time trajectory tracking and speed control commands, etc.). The robot driving unit 52 may include, but is not limited to, at least one wheel and at least one drive motor connected to the at least one wheel and rotating the at least one wheel (e.g., in differential or omnidirectional configurations, etc.). The robot driving unit 52 may further include a steering device for steering the robot 50 and a heading adjustment device for controlling the heading direction of the robot 50, For example, the heading direction of the sensor unit 10 (e.g., by rotating a camera gimbal, LiDAR platform, or steering axle to align with the selected target heading, etc.).

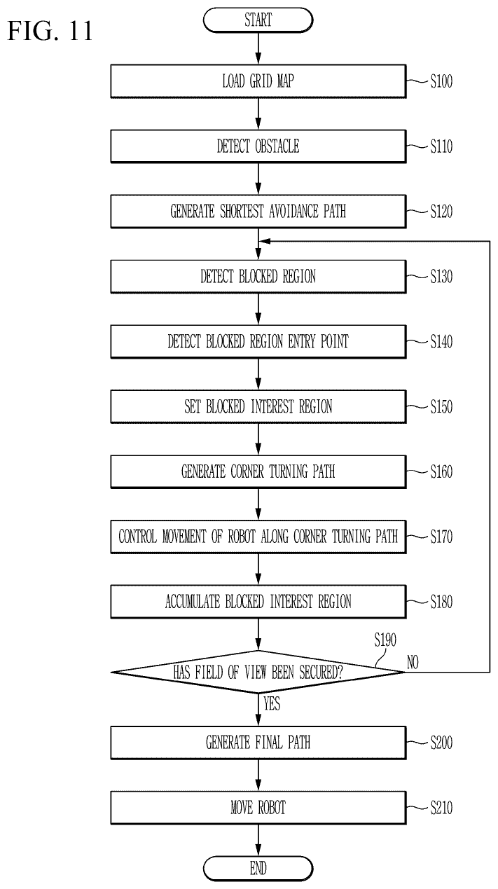

Hereinafter, the real-time path generation method for corner turning of the robot according to another example of the present disclosure will be described with reference to FIG. 11 (e.g., which outlines the sequential decision-making and control logic executed by the system during navigation near corners, etc.). FIG. 11 shows an example of the real-time path generation method for corner turning of the robot according to another example of the present disclosure (e.g., showing functional steps from sensing to final path execution, etc.).

As shown in FIG. 11, the real-time path generation method for corner turning of the robot according to another example of the present disclosure may start at step S100 (e.g., initiating the sensing and mapping phase to establish environmental awareness prior to path planning, etc.). In order to perform the step S100, the sensor unit 10 may detect the sensor data 68 within the field of view and transmit the detected sensor data 68 to the controller 20 (e.g., including obstacle geometry, environmental features, or spatial gaps, etc.).

The cost map generation unit may load the grid map stored in the controller 20 at the step S100, and the obstacle detection unit 22 of the controller 20 may detect the obstacle based on the sensor data 68 at step S110 (e.g., by processing point cloud data, image frames, or fused sensor inputs to identify objects obstructing the path, etc.). An execution order of the steps S100 and S110 is not limited to the shown order (e.g., either can occur first or in parallel, depending on system architecture and data availability).

When the grid map is loaded and the obstacle 88 is detected, the cost map generation unit may generate the occupancy grid map based on the grid map and the obstacle information, and generate the cost map 60 for the surroundings of the robot 50 based on the occupancy grid map and the obstacle information (e.g., assigning traversal costs based on obstacle proximity, surface characteristics, or movement constraints, etc.).

When the cost map 60 is generated, the shortest avoidance path generation unit 26 may generate the shortest avoidance path 70 along which the destination 66 may be reached from the current position of the robot 50 while avoiding the obstacle by using the path generation algorithm based on the cost map 60 at step S120 (e.g., using A, Dijkstra's algorithm, or other cost-minimizing planners, etc.).

The blocked region detection unit 24 of the controller 20 may detect the blocked region 76, which is the region not detected by the sensor unit 10 at the current position of the robot 50, based on the sensor data 68 at step S130 (e.g., by comparing the current field of view against mapped regions to identify occluded zones), and the blocked region entry point detection unit 28 may detect the blocked region entry point 78 by utilizing the shortest avoidance path 70 received from the shortest avoidance path generation unit 26 and the blocked region 76 received from the blocked region detection unit 24 at step S140 (e.g., by identifying the first node where the path transitions into an undetected area).

If the blocked region entry point 78 is detected, the blocked region entry point detection unit 28 may set the certain section around the preset number of nodes 72 following the blocked region entry point 78 as the blocked interest region 80 at step S150 (e.g., defining a region of interest that must be monitored for visibility during corner approach).

The corner turning path generation unit 30 may generate the corner turning path 82 based on the shortest avoidance path 70 received from the shortest avoidance path generation unit 26 and the blocked region entry point 78 received from the blocked region entry point detection unit 28 by using the preset algorithm at step S160 (e.g., by expanding the path outward from the turn to maximize visibility and maintain clearance from occlusions). Thereafter, the corner turning path 82 generated by the corner turning path generation unit 30 may be transmitted to the path selection unit 36 and then transmitted to the path following unit 42 (e.g., for evaluation against alternate paths and for eventual execution by the robot's motion control system, etc.). Then, the path following unit 42 may control the driving and the steering of the robot 50 to move the robot 50 such that the robot 50 follows the final path 86 (e.g., the corner turning path 82) received from the path selection unit 36 at step S170 (e.g., by generating corresponding motor and steering commands in real time).

In a state in which the robot 50 moves along the final path 86, the blocked interest region accumulation unit 32 may accumulate the blocked interest region 80 transmitted from the blocked region entry point detection unit 28 from the initial time t0 at which the shortest avoidance path 70 is generated to the current time at every preset time interval, thereby generating the accumulated blocked interest region 84 at step S180 (e.g., to track visibility progress toward full coverage of the occluded zone).

Then, the viewing angle securing determination unit 34 may determine whether the field of view of the sensor unit 10 has been sufficiently secured based on the accumulated blocked interest region 84 transmitted from the blocked interest region accumulation unit 32 (e.g., by verifying whether all nodes in the blocked region have come into view over time). In a case where the field of view has not been sufficiently secured at step S190, For example, in a case where the sensor unit 10 does not detect even a portion of the accumulated blocked interest region 84, the method returns to the step S130 and repeats the steps S130 to S190 (e.g., continuing corner navigation and visibility updates until full coverage is achieved). In a case where the field of view has been sufficiently secured at the step S190, For example, in a case where the sensor unit 10 may detect the entire accumulated blocked interest region 84, the path selection unit 36 may select one of the shortest avoidance path 70 transmitted from the shortest avoidance path generation unit 26 and the corner turning path 82 transmitted from the corner turning path generation unit 30 as the final path 86 based on:
the information regarding whether the blocked region entry point 78 has been detected, which is transmitted from the blocked region entry point detection unit 28 (e.g., indicating whether the robot is still approaching an unobserved corner or has passed it and can resume a more direct route, etc.),
the information regarding whether the accumulated blocked interest region 84 exists, which is transmitted from the blocked interest region accumulation unit 32 (e.g., to determine whether the visibility condition has been satisfied across all previously unobservable regions and whether corner-based maneuvering is still necessary, etc.), and
the information regarding whether the field of view has been secured, which is transmitted from the viewing angle securing determination unit 34 at step S200 (e.g., confirming that all relevant occluded areas have entered the sensor's field of view, thereby allowing a safe transition to a more direct path).

Then, the path following unit 42 may control the driving and the steering of the robot 50 to move the robot 50 such that the robot 50 follows the final path 86 received from the path selection unit 36 at step S210 (e.g., by converting path data into motion and heading control commands in real time).

In order to secure the field of view as quickly as possible when the robot 50 moves along the final path 86 at the step S170, the method may further include assigning the heading direction advantageous for securing the field of view to each final node included in the final path 86, and selecting the final target heading direction based on the final path 86 and the heading directions assigned to all final nodes included in the final path 86 (e.g., to proactively orient the robot or its sensors toward regions not yet visible, particularly when turning around blind corners).

More specifically, the viewing angle securing heading assignment unit 38 may assign, as the heading direction, the direction so as to view the preset distance ahead or view the final node which is ahead by the preset number ahead to each final node included in the final path 86 (e.g., allowing the robot to look ahead by a fixed spatial interval or number of steps to improve cornering visibility and responsiveness). The preset distance or the preset number is not particularly limited, and may be set based on, for example, sensor range, robot speed, or environmental constraints.

Further, the target heading selection unit 40 may set the target heading direction by adding the additional distance or the additional number according to the driving state of the robot 50 to the preset distance or the preset number assigned to each final node (e.g., dynamically extending the lookahead distance in high-speed conditions or tighter turns to ensure sufficient foresight).

The target heading selection unit 40 may transmit the set target heading direction to the path following unit 42, and the path following unit 42 may control the robot 50, particularly the sensor unit 10, to be directed to the target heading direction (e.g., by adjusting the robot's orientation or actuating a gimbal, pan-tilt unit, or steering mechanism to align the sensor field of view accordingly, etc.).

A real-time path generation method for corner turning of a robot according to an example of the present disclosure includes: generating, by a controller, a cost map for surroundings of the robot based on a grid map and information regarding an obstacle detected by a sensor unit; generating, by the controller, a shortest avoidance path along which a destination is reachable from a current position of the robot while avoiding the obstacle based on the cost map; detecting, by the controller, a blocked region which is a region not detected by the sensor unit at the current position of the robot; detecting, by the controller, a blocked region entry point using the shortest avoidance path and the blocked region; generating, by the controller, a corner turning path using the shortest avoidance path and the blocked region entry point; controlling, by the controller, movement of the robot along the corner turning path; determining, by the controller, whether a field of view has been secured at every preset time interval; and generating, by the controller, one of the shortest avoidance path and the corner turning path as a final path based on a result of determining whether the field of view has been secured.

The detecting a blocked region entry point using the shortest avoidance path and the blocked region may include: checking which region among a sensor detection region and the blocked region all nodes included in the shortest avoidance path belong to sequentially from the current position of the robot to the destination; and detecting a first node that belongs to the sensor detection region and then to the blocked region as the blocked region entry point.

The determining whether a field of view has been secured may include: setting a certain section following the blocked region entry point as a blocked interest region; accumulating the blocked interest region from an initial time at which the shortest avoidance path is generated to a current time to generate an accumulated blocked interest region; and determining whether an entire accumulated blocked interest region is detected by the sensor unit.

It may be determined that the field of view has been secured in a case where the entire accumulated blocked interest region is detected, and it may be determined that the field of view has not been secured in a case where even a portion of the accumulated blocked interest region is not detected.

The generating one of the shortest avoidance path and the corner turning path as the final path may include generating the shortest avoidance path as the final path in response to determining that the field of view has been secured.

The generating one of the shortest avoidance path and the corner turning path as the final path may further include generating the corner turning path as the final path in response to determining that the field of view has not been secured.

The real-time path generation method may further include controlling, by the controller, the movement of the robot along the final path.

The real-time path generation method may further include: assigning, by the controller, a heading direction to each final node included in the final path; setting, by the controller, a target heading direction for each final node based on the final path and the heading direction assigned to each final node included in the final path; and controlling, by the controller, the field of view of the sensor unit according to the target heading direction.

The assigning a heading direction to each final node may include assigning, as the heading direction for each final node, a direction so as to view a preset distance ahead or view a final node which is ahead by a preset number.

The setting a target heading direction for each final node may include setting the target heading direction by adding an additional distance or an additional number according to a driving state of the robot to a preset distance or a preset number assigned to each final node.

A real-time path generation system for corner turning of a robot according to another example of the present disclosure includes: a sensor unit configured to detect sensor data within a field of view; and a controller configured to receive the sensor data from the sensor unit, generate a path from a current position of the robot to a destination, and control the robot to move according to the generated path, in which the controller is configured to: generate a cost map for surroundings of the robot based on a grid map and information regarding an obstacle detected by the sensor unit, generate a shortest avoidance path along which the destination is reachable from the current position of the robot while avoiding the obstacle based on the cost map, detect a blocked region which is a region not detected by the sensor unit at the current position of the robot, detect a blocked region entry point using the shortest avoidance path and the blocked region, generate a corner turning path based on the shortest avoidance path and the blocked region entry point, control movement of the robot along the corner turning path, determine whether a field of view has been secured at every preset time interval, and generate one of the shortest avoidance path and the corner turning path as a final path based on a result of determining whether the field of view has been secured.

When detecting the blocked region entry point using the shortest avoidance path and the blocked region, the controller may be configured to check which region among a sensor detection region and the blocked region all nodes included in the shortest avoidance path belong to sequentially from the current position of the robot to the destination, and detect a first node that belongs to the sensor detection region and then to the blocked region as the blocked region entry point.

When determining whether the field of view has been secured, the controller may be configured to set a certain section following the blocked region entry point as a blocked interest region, accumulate the blocked interest region from an initial time at which the shortest avoidance path is generated to a current time to generate an accumulated blocked interest region, and determine whether an entire accumulated blocked interest region is detected by the sensor unit.

The controller may be configured to determine that the field of view has been secured in a case where the entire accumulated blocked interest region is detected, and determine that the field of view has not been secured in a case where even a portion of the accumulated blocked interest region is not detected.

When generating one of the shortest avoidance path and the corner turning path as the final path, the controller may be configured to generate the shortest avoidance path as the final path in response to determining that the field of view has been secured.

When generating one of the shortest avoidance path and the corner turning path as the final path, the controller may be further configured to generate the corner turning path as the final path in response to determining that the field of view has not been secured.

The controller may be further configured to control the movement of the robot along the final path.

The controller may be further configured to: assign a heading direction to each final node included in the final path, set a target heading direction for each final node based on the final path and the heading direction assigned to each final node included in the final path, and control the field of view of the sensor unit according to the target heading direction.

When assigning the heading direction to each final node, the controller may be configured to assign, as the heading direction for each final node, a direction so as to view a preset distance ahead or view a final node which is ahead by a preset number.

When setting the target heading direction for each final node, the controller may be configured to set the target heading direction by adding an additional distance or an additional number according to a driving state of the robot to a preset distance or a preset number assigned to each final node.

According to the present disclosure, a real-time path that may make a large turn at a corner may be generated, so that safety for an object approaching from the opposite side of the corner, which is a region that is difficult to detect in advance with a sensor, may be secured. In addition, the real-time path is generated, and a heading direction that may secure a field of view as quickly as possible is assigned, and thus, it is possible to respond in advance to objects approaching from the opposite side of the corner, thereby more safely and smartly coping with the corner.

While the present disclosure has been described in connection with what is presently considered to be practical examples, it is to be understood that the present disclosure is not limited to the disclosed examples. On the contrary, it is intended to cover various modifications and equivalent arrangements included within the spirit and scope of the appended claims.

What is claimed:

1. A method performed by an apparatus of a robot, the method comprising:
based on a grid map and information regarding an obstacle detected by a sensor of the robot, generating a cost map for surrounding areas of the robot, wherein the surrounding areas are within a threshold distance from the robot;
generating, based on the cost map, a shortest avoidance path from a current position of the robot to a destination such that the shortest avoidance path bypasses the obstacle;
detecting a blocked region that is outside a sensor detection region detected by the sensor at the current position of the robot;
detecting, based on the shortest avoidance path and the blocked region, a blocked region entry point;
generating, based on the shortest avoidance path and the blocked region entry point, a corner turning path;
determining whether a field of view of the sensor has been secured at every preset time interval;
generating, based on the determining, one of the shortest avoidance path and the corner turning path as a final path;
outputting a signal indicating the final path; and
controlling, based on the signal, movement of the robot.

2. The method of claim 1, wherein the detecting of the blocked region entry point comprises:
checking, for each node included in the shortest avoidance path sequentially from the current position of the robot to the destination, whether the node belongs to the sensor detection region or the blocked region; and
identifying, as the blocked region entry point, a first node that transitions from the sensor detection region to the blocked region.

3. The method of claim 1, wherein the determining of whether the field of view has been secured comprises:
setting a certain section following the blocked region entry point as a blocked interest region;
accumulating the blocked interest region to generate an accumulated blocked interest region, wherein the blocked interest region is accumulated from an initial time to a current time, and wherein the initial time is a time at which the shortest avoidance path is generated; and
determining whether the accumulated blocked interest region is detected by the sensor.

4. The method of claim 3, wherein the determining of whether the field of view has been secured comprises:
determining that the field of view has been secured based on the accumulated blocked interest region being entirely detected, or
determining that the field of view has not been secured based on the accumulated blocked interest region being partially detected.

5. The method of claim 1, wherein the generating of one of the shortest avoidance path and the corner turning path as the final path comprises:
generating, based on determining that the field of view has been secured, the shortest avoidance path as the final path.

6. The method of claim 1, wherein the generating of one of the shortest avoidance path and the corner turning path as the final path comprises:
generating, based on determining that the field of view has not been secured, the corner turning path as the final path.

7. The method of claim 1, wherein the controlling of the movement of the robot comprises controlling movement of the robot along the final path.

8. The method of claim 7, further comprising:
assigning a heading direction to each final node included in the final path;
setting, based on the final path and the heading direction, a target heading direction for each final node; and
controlling, based on the target heading direction, the field of view of the sensor.

9. The method of claim 8, wherein the assigning of a heading direction comprises:
assigning, as the heading direction for each final node, a direction toward:
a location that is ahead on the final path by a preset distance, or
a final node that is ahead by a preset number of nodes.

10. The method of claim 8, wherein the setting of the target heading direction comprises:
based on a driving state of the robot, setting the target heading direction by adding:
an additional distance to a preset distance assigned to each final node, or
an additional number to a preset number assigned to each final node.

11. An apparatus of a robot, the apparatus comprising:
a processor; and
a memory storing at least one instruction that, when executed by the processor communicating with the memory, is configured to cause the apparatus to:
detect, using a sensor of the robot, sensor data within a field of view of the sensor; and
based on a grid map and the sensor data, generate a cost map for surrounding areas of the robot, wherein the surrounding areas are within a threshold distance from the robot,
generate, based on the cost map, a shortest avoidance path from a current position of the robot to a destination such that the shortest avoidance path bypasses an obstacle, wherein the obstacle is detected based on the sensor data,
detect a blocked region that is outside a sensor detection region detected by the sensor at the current position of the robot,
detect, based on the shortest avoidance path and the blocked region, a blocked region entry point,
generate, based on the shortest avoidance path and the blocked region entry point, a corner turning path,
determine whether a field of view of the sensor has been secured at every preset time interval,
generate, based on the determination, one of the shortest avoidance path and the corner turning path as a final path,
output a signal indicating the final path, and
control, based on the signal, movement of the robot.

12. The apparatus of claim 11, wherein the at least one instruction, when executed by the processor communicating with the memory, is configured to cause the apparatus to detect the blocked region entry point by:
checking, for each node included in the shortest avoidance path sequentially from the current position of the robot to the destination, whether the node belongs to the sensor detection region or the blocked region, and
identifying, as the blocked region entry point, a first node that transitions from the sensor detection region to the blocked region.

13. The apparatus of claim 11, wherein the at least one instruction, when executed by the processor communicating with the memory, is configured to cause the apparatus to determine whether the field of view has been secured by:
setting a certain section following the blocked region entry point as a blocked interest region,
accumulating the blocked interest region to generate an accumulated blocked interest region, wherein the blocked interest region is accumulated from an initial time to a current time, and wherein the initial time is a time at which the shortest avoidance path is generated, and
determining whether the accumulated blocked interest region is detected by the sensor.

14. The apparatus of claim 13, wherein the at least one instruction, when executed by the processor communicating with the memory, is configured to cause the apparatus to:
determine, based on the accumulated blocked interest region being entirely detected, that the field of view has been secured, and
determine, based on the accumulated blocked interest region being partially detected, that the field of view has not been secured.

15. The apparatus of claim 11, wherein the at least one instruction, when executed by the processor communicating with the memory, is configured to cause the apparatus to generate, based on determining that the field of view has been secured, the shortest avoidance path as the final path.

16. The apparatus of claim 11, wherein the at least one instruction, when executed by the processor communicating with the memory, is configured to cause the apparatus to generate, based on determining that the field of view has not been secured, the corner turning path as the final path.

17. The apparatus of claim 11, wherein the at least one instruction, when executed by the processor communicating with the memory, is configured to cause the apparatus to control the movement of the robot along the final path.

18. The apparatus of claim 17, wherein the at least one instruction, when executed by the processor communicating with the memory, is configured to cause the apparatus to:
assign a heading direction to each final node included in the final path,
set, based on the final path and the heading direction, a target heading direction for each final node, and
control, based on the target heading direction, the field of view of the sensor.

19. A method performed by an apparatus of a vehicle, the method comprising:
obtaining information related to an environment of the vehicle;
generating, based on the obtained information, a path for movement of the vehicle from a current position toward a destination;
identifying a region along the path;
determining whether the region is entirely within a sensing range of a sensor of the vehicle;
based on the determination of whether the region is entirely within the sensing range, adjusting the path;
outputting a signal indicating the adjusted path; and
controlling, based on the signal, the movement of the vehicle.

20. The method of claim 19, wherein the identifying of the region comprises:
identifying a blocked region entry point at which the path transitions from a sensor detection region into a region not currently detected by the sensor; and
defining the region as a blocked interest region that includes a portion of the path following the blocked region entry point, and wherein the vehicle comprises a robot.
